(19) United States
(12) Patent Application Publication
(10) Pub. No.: US 2026/0143061 A1
(43) Pub. Date: May 21, 2026

(54) Personal Safety and Emergency Alert System

(71) Applicant: Chip Coon, Cincinnati, OH (US)

(72) Inventor: Chip Coon, Cincinnati, OH (US)

(21) Appl. No.: 19/171,487

(22) Filed: Apr. 7, 2025

Related U.S. Application Data
(60) Provisional application No. 63/722,097, filed on Nov. 19, 2024.

(51) Int. Cl. H04M 1/72421; G06F 21/31; G08B 25/01; G08B 25/10; H04M 1/72448

(52) U.S. Cl. CPC H04M 1/72421; G06F 21/31; G08B 25/016; G08B 25/10; H04M 1/72448

(57) ABSTRACT

The present invention relates to a personal safety and alert system that comprises a mobile software application installed on an electronic device, such as a smartphone or smartwatch. The application includes a user interface for selecting different security modes, including a Green Mode for general recording, a Yellow Mode for discreet tracking, and a Red Mode for emergency situations. The system features a location module for real-time GPS tracking, a media recording module for capturing encrypted photos and videos, and a communication module for transmitting emergency alerts to predefined contacts. When activated in Red Mode, the system triggers an audible alarm, increases device volume, and automatically dials 911.

### CROSS-REFERENCE TO RELATED APPLICATION

The present application claims priority to, and the benefit of, U.S. Provisional Application No. 63/722,097, which was filed on Nov. 19, 2024, and is incorporated herein by reference in its entirety.

### FIELD OF THE INVENTION

The present invention generally relates to personal safety and emergency alert systems. More specifically, the invention pertains to a mobile software application designed to enhance individual security by providing automated recording, GPS tracking, and real-time emergency communication. The application is installed on a mobile electronic device, such as a smartphone, smartwatch, or tablet, and allows users to activate different security modes based on their level of perceived danger. Additionally, the application features an emergency response mechanism, which, when activated, can trigger an audible alarm, increase device volume, and automatically contact emergency services such as 911. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals frequently find themselves in situations where personal safety may be compromised or where documenting an incident is necessary. People attending public events, traveling alone, or walking through isolated areas, especially at night, are at an increased risk of encountering dangerous situations such as muggings, assaults, or harassment. In such instances, individuals often lack an effective way to record evidence or alert authorities in real time.

Furthermore, bystanders witnessing suspicious activity, crimes, or emergencies may struggle to efficiently document and report the incident to law enforcement. Traditional means of contacting emergency services, such as dialing 9-1-1, may not always be feasible, particularly in high-stress situations or when a person is physically unable to operate their device. Additionally, medical emergencies can arise unexpectedly, leaving individuals in critical need of immediate assistance which may not always been available. One of the major concerns in such scenarios is the lack of a reliable and quick method to record, store, and share information regarding an emergency. Without proper documentation, individuals may struggle to provide evidence supporting their claims, which can be crucial for law enforcement investigations or legal proceedings. Accordingly, there is a growing need for a personal safety and alert system that allows individuals to discreetly record incidents, share real-time location data, and notify emergency contacts or authorities with minimal effort.

Therefore, there exists a long-felt need in the art for a safety and alert system that functions as a safety mechanism for people traveling alone, preventing them from being put in difficult and dangerous situations without any way to record evidence or call for help. There is a long-felt need for a personal security solution that allows users to quickly document their surroundings, activate alerts, and notify emergency contacts or law enforcement. Additionally, there is a long-felt need for a mobile application that facilitates real-time media recording, location tracking, and emergency calling without requiring manual intervention in high-risk situations. Furthermore, there is a long-felt need for a system that provides different levels of alert activation, allowing users to choose a mode based on the severity of their situation. More specifically, there exists a long-felt need in the art for an emergency alert system that integrates automated recording, GPS tracking, and immediate emergency notifications, ensuring swift action during life-threatening circumstances. Also, there is a long-felt need in the art for a discreet safety solution that allows users to monitor potential risks and escalate alerts if needed without drawing attention. Finally, there is a long-felt need for an innovative security tool that offers a way to improve safety for men and women on college campuses, people traveling in foreign cities, individuals walking home alone from work, and much more.

The subject matter disclosed and claimed herein, in one embodiment, comprises a personal safety and alert system. The system includes a mobile software application installed on an electronic device, such as a smartphone or smartwatch, enabling users to activate different security modes tailored to varying levels of risk. The application features a traffic-light-based user interface, allowing users to select Green Mode for recording general information, Yellow Mode for discreet tracking and alerting, and Red Mode for emergency situations requiring immediate action. The system also comprises a location module that retrieves real-time GPS data, allowing for continuous tracking and secure transmission of location information to emergency contacts. Additionally, the system includes a media recording module that captures and encrypts photos and videos upon activation, ensuring that all recorded data remain secure and accessible for law enforcement or legal purposes. The system is further equipped with a communication module that transmits media files, location data, and automated emergency messages to predefined contacts via encrypted channels. Furthermore, upon activation of Red Mode, the system automatically triggers an emergency alarm, increases the device's volume, and dials 911 for immediate assistance.

In this manner, the safety and alert system of the present invention fulfills the long-felt need for a comprehensive personal security solution by integrating real-time recording, GPS tracking, and emergency notifications into a single mobile application. The system allows users to document, alert, and seek assistance based on the severity of their situation while ensuring that emergency contacts and law enforcement receive accurate, time-stamped data for response coordination. By providing an easy-to-use, scalable, and efficient safety tool, the system offers a reliable solution for individuals facing uncertain or dangerous environments.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a safety and alert system. The system comprises a mobile electronic device executing a software application that enables users to activate different safety modes based on their security needs. The system includes a user interface module that provides a selection of alert modes and an authentication module that allows secure access through biometric authentication or password-based login. The system further includes an alert and activation module that allows both manual and automatic activation of safety features. Upon activation, a media recording module captures and stores encrypted media files, while a communication module transmits the recorded media along with the user's real-time GPS location to predefined emergency contacts. Additionally, the system is configured to connect to a server via a communication network, enabling remote storage of recorded data and providing integration with emergency response services.

In another embodiment, the safety and alert system further includes an alert and activation module with three distinct alert modes, each providing a different level of response based on the severity of the situation. The Green Mode allows users to record media and share it with selected contacts when they feel the need to document their surroundings but are not in immediate danger. The Yellow Mode discreetly captures a burst of images and videos along with GPS location data and automatically transmits them to emergency contacts without alerting potential threats. The Red Mode is designed for critical emergency situations, triggering a loud alarm, increasing the device's volume to maximum, recording media in real-time, automatically contacting emergency services such as 911, and sending live location data to emergency contacts.

In one embodiment, a mobile software application for a personal safety and alert system is disclosed, wherein the application provides users with an interface to select different security modes based on their safety concerns. The application includes a traffic-light themed user interface where users can select Green Mode for recording media in non-emergency situations, Yellow Mode for discreet tracking and transmission of GPS and media data, and Red Mode for emergency scenarios requiring immediate response. The application further comprises a location module that retrieves and updates real-time GPS data of the user's mobile device, ensuring accurate tracking during an emergency. A media recording module is incorporated into the application, allowing for the capture and encryption of photos and videos to prevent unauthorized access. Additionally, a communication module transmits the recorded media and GPS location data to predefined emergency contacts using encrypted messaging to maintain security and privacy.

In yet another aspect, a method for activating a safety and alert system is disclosed, wherein a user selects one of multiple alert modes, including Green, Yellow, or Red, through a mobile software application. Upon activation, the method involves initiating a recording session using the mobile device's camera and microphone to capture real-time visual and audio data. The method further includes retrieving and updating the user's GPS location through a location module integrated within the mobile application. Once the media files and GPS data are captured, they are encrypted and transmitted to a predefined emergency contact list to ensure secure communication. If Red Mode is activated, the method further includes triggering an audible alarm to alert bystanders, increasing the device's volume to maximum, and automatically initiating a 911 emergency call.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a schematic view of safety and alert system of the present invention in accordance with the disclosed architecture;

FIG. 2 illustrates an exemplary home screen of the safety mobile application in accordance with one embodiment of the present invention;

FIG. 3 illustrates an exemplary user interface on activation of the first indicator (information mode or green mode) in accordance with one embodiment of the present invention;

FIG. 4 illustrates a user interface showing recording of an event/surrounding in green mode in accordance with one embodiment of the present invention;

FIG. 5 illustrates a user interface for yellow mode or second indicator in accordance with one embodiment of the present invention;

FIG. 6 illustrates a user interface showing recording of an event/surrounding in yellow mode in accordance with one embodiment of the present invention;

FIG. 7 illustrates a user interface showing the application in emergency mode (third indicator) in accordance with one embodiment of the present invention;

FIG. 8 illustrates a user interface of the mobile application for configuration of the application in accordance with the disclosed architecture;

FIG. 9 illustrates another user interface displayed by the software application for configuration of different parameters in accordance with the disclosed architecture;

FIG. 10 illustrates a flow chart depicting a process of emergency mode or red mode in accordance with one embodiment of the present invention; and

FIG. 11 illustrates an exemplary user device used for installation of the software application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a safety and alert system that functions as a safety mechanism for people traveling alone, preventing them from being put in difficult and dangerous situations without any way to record evidence or call for help. There is a long-felt need for a personal security solution that allows users to quickly document their surroundings, activate alerts, and notify emergency contacts or law enforcement. Additionally, there is a long-felt need for a mobile application that facilitates real-time media recording, location tracking, and emergency calling without requiring manual intervention in high-risk situations. Furthermore, there is a long-felt need for a system that provides different levels of alert activation, allowing users to choose a mode based on the severity of their situation. More specifically, there exists a long-felt need in the art for an emergency alert system that integrates automated recording, GPS tracking, and immediate emergency notifications, ensuring swift action during life-threatening circumstances. Also, there is a long-felt need in the art for a discreet safety solution that allows users to monitor potential risks and escalate alerts if needed without drawing attention. Finally, there is a long-felt need for an innovative security tool that offers a way to improve safety for men and women on college campuses, people traveling in foreign cities, individuals walking home alone from work, and much more.

The present invention, in one exemplary embodiment, is a safety and alert system. The system comprises a mobile electronic device executing a software application that enables users to activate different safety modes based on their security needs. The system includes a user interface module that provides a selection of alert modes and an authentication module that allows secure access through biometric authentication or password-based login. The system further includes an alert and activation module that allows both manual and automatic activation of safety features. Upon activation, a media recording module captures and stores encrypted media files, while a communication module transmits the recorded media along with the user's real-time GPS location to predefined emergency contacts. Additionally, the system is configured to connect to a server via a communication network, enabling remote storage of recorded data and providing integration with emergency response services.

Reference will now be made in detail to the present preferred embodiments of the invention, examples of which are illustrated in the accompanying drawings. Wherever possible, the same reference numerals are used in the drawings and the description to refer to the same or like parts.

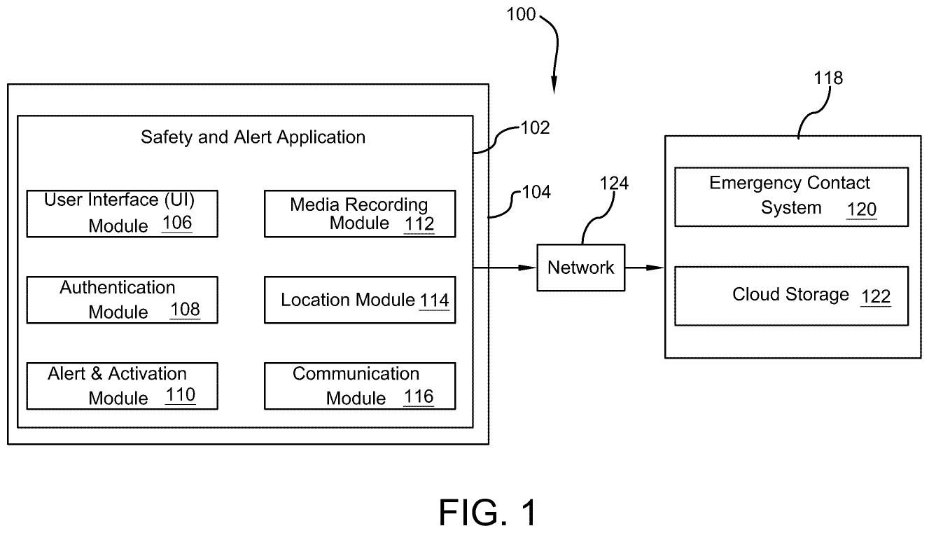

Referring initially to the drawings, FIG. 1 illustrates a schematic view of safety and alert system 100 of the present invention in accordance with the disclosed architecture. The safety and alert system 100 of the present invention is designed to protect individuals in uncertain or dangerous environments. More specifically, the system 100 provides different levels of alertness with automated recording, GPS tracking, and emergency calling to help prevent crime, assist law enforcement, and offer peace of mind to users and their families. The system 100 includes a software application 102 which can be installed in a mobile electronic device 104 such as but not limited to a smartphone, smartwatch, tablet, or any other similar device.

The software or mobile application 102 includes a user interface (UI) module 106 for providing different user interfaces for accessing functionalities provided by the application 102. The user interface module 106 displays different user settings to configure different states of the application 102. An authentication module 108 is used for enabling user registration and login to the personal safety and emergency alert system 100. The authentication module 108 can allow different authentication methods including but not limited to passcode, voice-ID, fingerprint, Face ID, etc. for authentication of a user for accessing the application 102.

An alert and activation module 110 enables a user to activate different modes of the application 102 as per their preferences. The module 110 also enables both manual and automatic activation of the application 102 for monitoring the surroundings of a user holding the device 104. The module 110 also auto-starts camera and microphone access of the device 104 upon activation of the application 102. A media recording module 112 is configured to store media recorded by the application 102. The storage is preferably encrypted and can also be uploaded to a central cloud storage. The recording module 112 can be configured to store various file formats including but not limited to .jpg, .jpeg, .mp3, .mp4, HEIC, HEVC, TIFF, PNG, GIF, WebP, and more.

A location module 114 is included in the application 102 and allows the application 102 to access and utilize the user's device 104 location data and may enable features like displaying nearby businesses, providing location-based recommendations, and tracking movement within the application 102. The location module 114 preferably uses the existing GPS system of the device 104 and requires an explicit approval from the user for using the GPS system of the device 104.

A communication module 116 enables automated messaging in the form of sending text messages, photos, videos, and location coordinates to emergency contacts. The communication module 116 also helps generate in-app siren and audible alerts to alert bystanders of the user holding the device 104. All the communication facilitated by the communication module 116 is encrypted and helps remote users and regulatory authorities to provide immediate help to the user using the application 102.

The application 102 is configured to be coupled to a server 118, which can be a cloud server, distributed server, or any other conventional public or private server. The server 118 includes a cloud storage 120 for storing media recording captured by the application 102. An emergency contact system 122 is included in the server 118 and can be used for storing emergency contact list for contact using the application 102. Further, the emergency contact system 122 can allow a cloud based online and offline emergency contact with regulatory authorities to provide immediate assistance to the users.

The application 102 and the server 118 are coupled using a communication network 124. The communication network 124 may include suitable logic, circuitry, and interfaces that may be configured to provide a plurality of network ports and a plurality of communication channels for transmission and reception of data related to operations of various entities (such as the user device 104 and the server system 118) of the personal safety and emergency alert system 100. The communication network 124 may be associated with an application layer for implementation of communication protocols based on one or more communication requests from the user device 104 and the server system 118. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel of a plurality of communication channels in the communication network 106. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

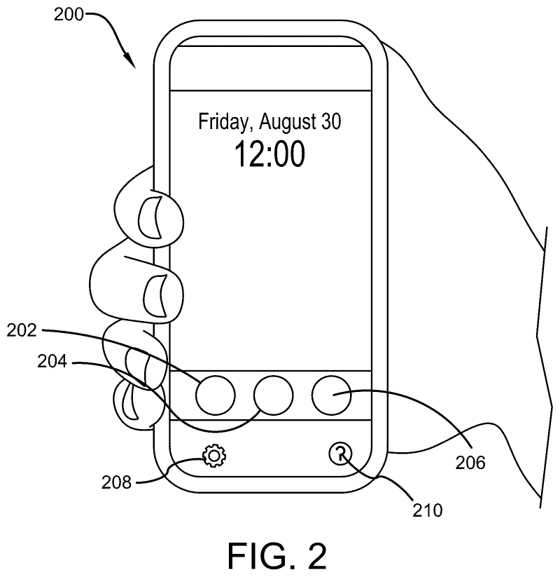

FIG. 2 illustrates an exemplary home screen 200 of the safety mobile application 102 in accordance with one embodiment of the present invention. The home screen 200 includes three indicators 202,204,206, each in a button or circular form wherein the first indicator 202 is in a first (preferably green color), the second indicator 204 is in a second color (preferably yellow), and the third indicator 206 is in a third color (preferably red). The first color, the second color, and the third color are different for providing a distinct appearance to each indicator 202,204,206.

Pressing the first indicator 202 activates an information mode which activates photo or video recording. The first indicator 202 is selected when there is no emergency and the user carrying the device 104 and using the application 102 is safe. The second indicator 204 activates a caution mode and activates photo and video recording along with GPS tracking. The third indicator 206 activates emergency mode and when activated, immediately activates emergency actions including but not limited to generating loud alarms, tracking GPS, automatic media capture, and initiating a 911 call.

The home screen 200 also displays a Settings icon 208 for configuring the display and other functional settings of the application 102. A Help icon 210 on selection provides various FAQs and helps content, enabling users to effectively use the system 100 for safety and protection.

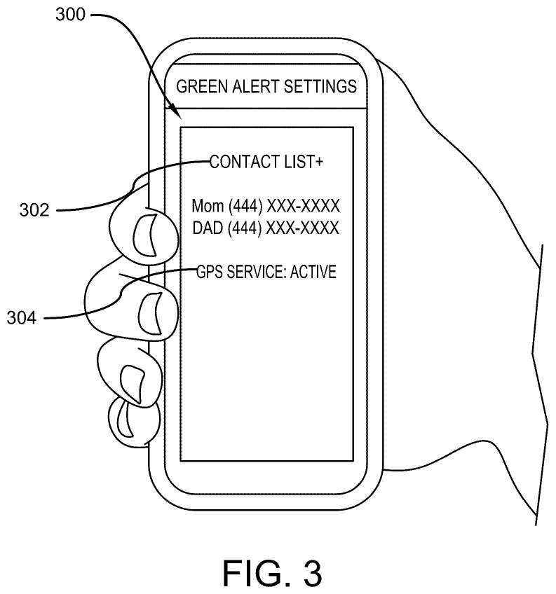

FIG. 3 illustrates an exemplary user interface 300 on activation of the first indicator 202 (information mode or green mode) in accordance with one embodiment of the present invention. The interface 300 is displayed when the first indicator 202 is selected for information mode or green mode. The interface 300 provides a list 302 of contacts and status 304 of the location module 114. In preferred embodiment, photos and videos captured by the application 102 can be sent to all the contacts in the list and in some cases, one or more contacts can be selected from the list 302.

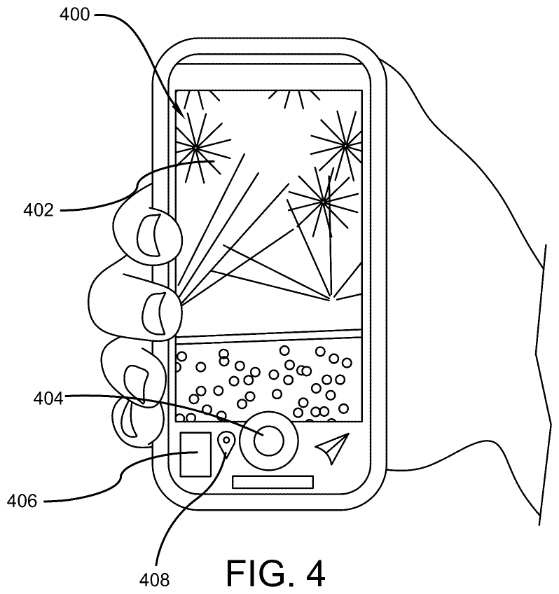

FIG. 4 illustrates a user interface 400 showing recording of an event/surrounding in green mode in accordance with one embodiment of the present invention. As illustrated, the interface 400 records the live photos or video 402 for a predetermined time period such as 10 seconds, 20 seconds, etc. A contact book 406 and an active location icon 408 are displayed on the interface 400. It should be noted that the recording is transmitted to the contacts (as described in FIG. 3) in real time. The recording can be stopped or activated using the record button 404.

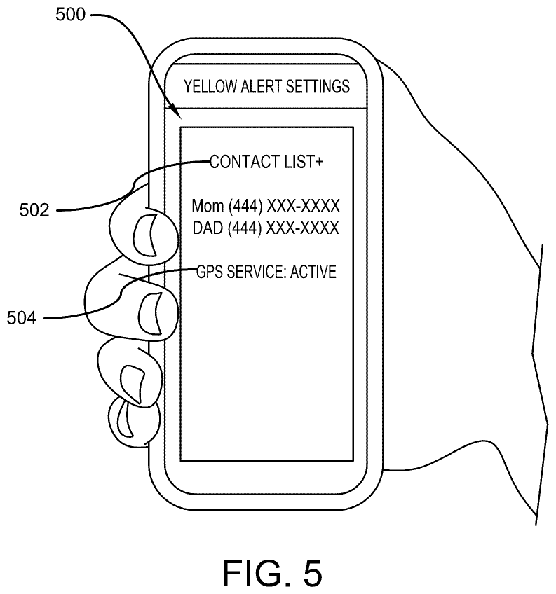

FIG. 5 illustrates a user interface 500 for yellow mode or second indicator in accordance with one embodiment of the present invention. The yellow mode using the second indicator 204 can be activated when a person enters a situation that could be dangerous, but they do not want to draw any attention to themselves. The yellow mode, when activated allows the application to take a burst of photos or videos along with GPS location of the device 104. A list 502 of contacts is displayed in the interface 500 along with the status 504 of the GPS/location service. It should be noted that in both the green mode and the yellow mode, the contact list can be edited as per preference of the user.

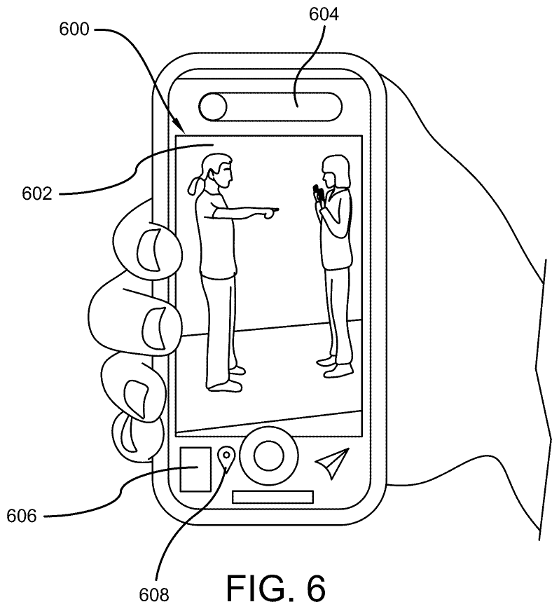

FIG. 6 illustrates a user interface 600 showing recording of an event/surrounding in yellow mode in accordance with one embodiment of the present invention. As illustrated, the interface 600 illustrates live video 602 which can be used for capturing burst of photos or videos. The scroll bar 604 is used discreetly sending capture of the surroundings of the user. A contact book 606 and an active location icon 608 are displayed on the interface 600.

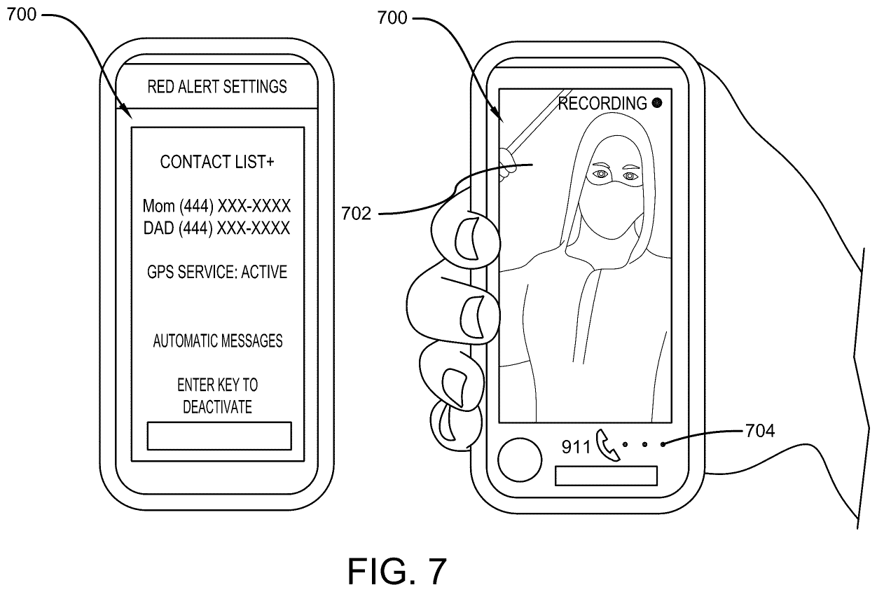

FIG. 7 illustrates a user interface 700 showing the application in emergency mode (third indicator) in accordance with one embodiment of the present invention. The emergency mode or the red mode is designed for immediate danger situations such as an attack, assault, or abduction. The emergency mode can be manually or automatically activated and in the emergency mode, the interface 700 increases volume of the device 104 and may produce unique audio alarm sounds and an audible voice phrase that indicates the application 102 has been activated. A predetermined duration such as 20 seconds of photos or videos 702 is automatically captured, and the location and the media files are sent in real time to the emergency contacts configured for the emergency mode. Preferably, a 911 call 704 is automatically initiated for providing immediate assistance to the user. The audible alarm and verbal announcement are generated to alert nearby people to the emergency and deter an attacker by making them aware of the recording.

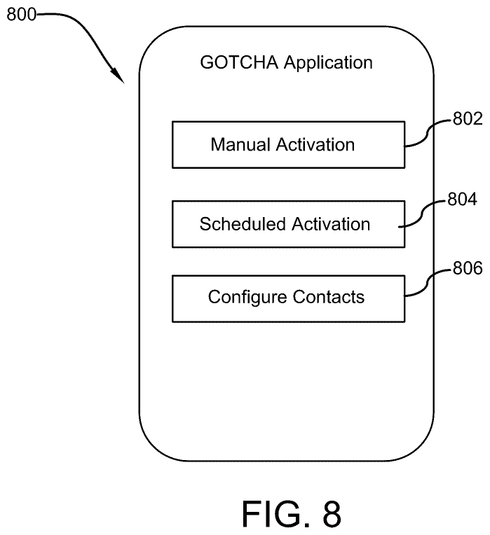

FIG. 8 illustrates a user interface 800 of the mobile application for configuration of the application in accordance with the disclosed architecture. As illustrated, the safety application 102 provides options for both manual activation and automatic activation of different modes. The manual activation option 802 allows a user to manually activate one or more modes (green, yellow, and red). The activation option can be selected individually and independently for each mode. A scheduled activation option 804 sets auto-activation schedule of one or more modes. In a non-limiting example, a user can set a scheduled activation of yellow mode when the user is walking home alone at night. Configure contacts option 806 enables users to add and edit contacts in the respective modes for transmission of captured photos and videos during activation of different modes.

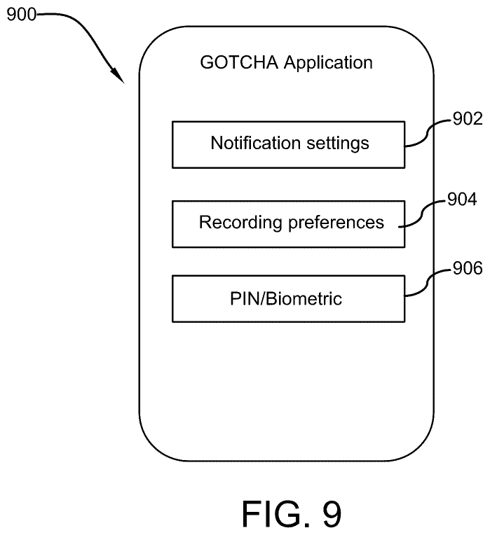

FIG. 9 illustrates another user interface 900 displayed by the software application for configuration of different parameters in accordance with the disclosed architecture. The interface 900 displays a Notification settings option 902 for adjusting alert volume, vibration, and other notification preferences of the application 102. A recording preference option 904 enables users to select one or more photo burst, video length, and resolution of the recorded media. A security setting option 906 may be provided for enabling PIN or biometric based authentication for accessing the application 102 and for a specific mode of the application 102.

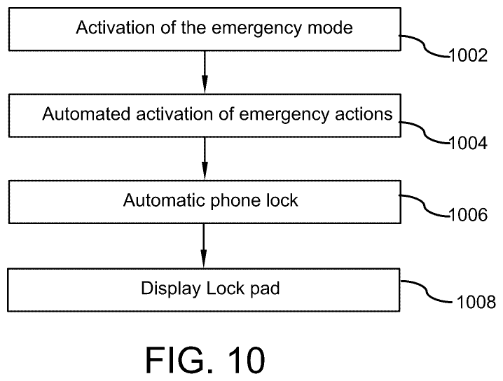

FIG. 10 illustrates a flow chart depicting a process of emergency mode or red mode in accordance with one embodiment of the present invention. Initially, the emergency mode (illustrated in FIG. 6) is activated either manually or can be a scheduled activation (Step 1002). On activation of the emergency mode, emergency actions such as siren, 911 call, automatic video and image recording are automatically activated (Step 1004). The phone is automatically locked and may display a message such as “Unlock with Security Code” (Step 1006). The phone is locked to prevent an attacker from disabling the emergency alert. Then, emergency lock screen with lock pad or any other security mechanism is displayed for the user to unlock the device along with a follow-up question such as “Are you safe now” (Step 1008).

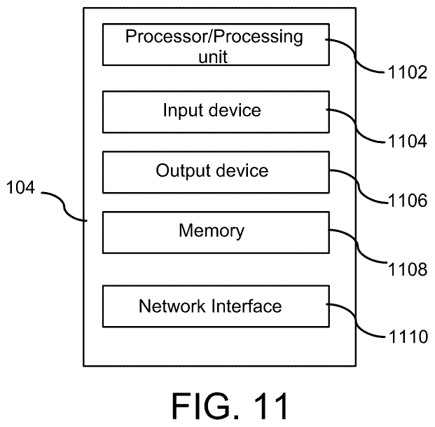

FIG. 11 illustrates an exemplary user device 104 used for installation of the software application of the present invention in accordance with the disclosed architecture. The processing unit 1102 may include suitable logic, instructions, circuitry, interfaces, and/or codes for executing various operations, such as the operations associated with the user device 104, or the like. The processing unit 1102 may be configured to control one or more operations executed by the user device 104 in response to the input received at the user device 104 from the user. The processor 1102 executes the computer readable instructions stored in the application 102. Examples of the processing unit 1102 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include or otherwise cover any type of the processing unit 1102 including known, related art, and/or later developed processing units. The user device 104 can further include one or more computer executable applications configured to be executed by the processing unit 1102. The one or more computer executable applications may include suitable logic, instructions, and/or codes for executing various operations. The one or more computer executable applications may be stored in the memory 1108. The one or more computer executable applications includes the application 102.

The user device 104 includes input device(s) 1104 such as a touch input device, voice input device, etc. for entering data and information. Preferably, the touch interface of the user device 104 is used as the input, and various buttons/tabs shown on the application 102 are pressed or clicked by the user. Other input devices such as a camera and microphone are used during video capture. The display of the user device 104 also acts as the output device 1106 for displaying various contents (e.g., text, images, videos, icons, and/or symbols, etc.) to the user. The display can include a touch screen, and may receive, for example, a touch, gesture, proximity, or hovering input using an electronic pen or a part of a user's body.

The electronic device 104 has memory 1108 used for storing programs (sequences of instructions) or data (e.g., program state information) on a temporary or permanent basis for use in the computer system. Memory 1108 can be configured for short-term storage of information as volatile memory and therefore does not retain stored contents if powered off. Examples of volatile memories include random access memories (RAM), dynamic random-access memories (DRAM), static random-access memories (SRAM), and other forms of volatile memories known in the art. The processor 1102, in combination with one or more of memory 1108, input device(s) 1104, output device(s) 1106 is utilized to provide users to execute instructions on the application 102. The connection to a network is provided by wireless interface 1110.

The wireless interface 1110 enables the user device 104 to communicate with the server and other components of the system 100 over the communication network, according to embodiments of the present disclosure. Examples of the communication interface 1110 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the communication interface 1110 may include any device and/or apparatus capable of providing wireless or wired communications between the user device 104 and the server.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “personal safety and emergency alert system”, “mobile security application”, “safety and alert system”, and “system” are interchangeable and refer to the personal safety and emergency alert system 100 of the present invention.

Notwithstanding the forgoing, the personal safety and emergency alert system 100 of the present invention can be of any suitable configuration as is known in the art without affecting the overall concept of the invention, provided that it accomplishes the above stated objectives. One of ordinary skill in the art will appreciate that the personal safety and emergency alert system 100 as shown in the FIGS. are for illustrative purposes only, and that many other configuration and design of the personal safety and emergency alert system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A personal safety and emergency alert system comprising:
a mobile electronic device;
a software application installed on the mobile electronic device, the software application comprising:
a user interface module configured to provide a user interface for accessing a functionality of the software application;
an authentication module configured to enable user authentication for accessing the software application;
an alert and activation module configured to activate a mode of the software application, wherein activation of a mode initiates a monitoring of a surrounding of the user using the mobile electronic device;
a media recording module configured to store a media recorded by the software application;
a location module configured to access and utilize a location data of the mobile electronic device;
a communication module configured to transmit a text message, a media files, and a location data to an emergency contact; and
a server communicatively coupled to the software application via a communication network.

2. The personal safety and emergency alert system of claim 1, wherein the authentication module enables authentication using a passcode, a voice ID, a fingerprint, or a face ID.

3. The personal safety and emergency alert system of claim 1, wherein the media recording module encrypts a stored media.

4. The personal safety and emergency alert system of claim 1, wherein the location module requires an explicit user approval for accessing a GPS system of the mobile electronic device.

5. The personal safety and emergency alert system of claim 1, wherein the communication module transmits data using an encrypted communication protocol.

6. The personal safety and emergency alert system of claim 1, wherein the communication module is configured to generate an audible siren.

7. A personal safety and emergency alert system comprising:
a mobile electronic device;
a software application installed on the mobile electronic device, the software application comprising:
a user interface module configured to provide a user interface for accessing a functionality of the software application;
an authentication module configured to enable user authentication for accessing the software application;
an alert and activation module configured to activate a mode of the software application, wherein activation of a mode initiates a monitoring of a surrounding of the user using the mobile electronic device and is configured to automatically initiate a camera and a microphone access of the mobile electronic device upon activation of the software application;
a media recording module configured to store a media recorded by the software application;
a location module configured to access and utilize a location data of the mobile electronic device;
a communication module configured to transmit a text message, a media files, and a location data to an emergency contact; and
a server communicatively coupled to the software application via a communication network.

8. The personal safety and emergency alert system of claim 7, wherein the authentication module enables authentication using a passcode, a voice ID, a fingerprint, or a face ID.

9. The personal safety and emergency alert system of claim 7, wherein the media recording module supports multiple file formats including a JPEG, an MP4, a HEIC, a TIFF, and a PNG.

10. The personal safety and emergency alert system of claim 7, wherein the software application automatically uploads a media recorded by the media recording module to the server in real time.

11. The personal safety and emergency alert system of claim 7, wherein the communication module transmits a text message, a media file, and a location data to the emergency contact using an encrypted communication protocol.

12. The personal safety and emergency alert system of claim 7, wherein the communication module enables real-time messaging to the emergency contact.

13. A personal safety and emergency alert system comprising:
a mobile electronic device;
a software application installed on the mobile electronic device, the software application comprising:
a user interface module configured to provide a user interface for accessing a functionality of the software application, the user interface comprised of a home screen displaying a first indicator, a second indicator, and a third indicator, wherein the first indicator, the second indicator, and the third indicator are configured to activate a first corresponding mode that initiates a photo or a video recording, a second corresponding mode that activates a caution mode to initiate a photo or a video recording along with a GPS tracking, and a third corresponding mode of the software application that activates an emergency mode to generate an alarm, track a GPS location, capture a media, and initiate an emergency call;
an authentication module configured to enable user authentication for accessing the software application;
an alert and activation module configured to activate a mode of the software application, wherein activation of a mode initiates a monitoring of a surrounding of the user using the mobile electronic device and is configured to automatically initiate a camera and a microphone access of the mobile electronic device upon activation of the software application;
a media recording module configured to store a media recorded by the software application;
a location module configured to access and utilize a location data of the mobile electronic device;
a communication module configured to transmit a text message, a media files, and a location data to an emergency contact; and
a server communicatively coupled to the software application via a communication network.

14. The personal safety and emergency alert system of claim 13, wherein the authentication module enables authentication using a passcode, a voice ID, a fingerprint, or a face ID.

15. The personal safety and emergency alert system of claim 13, wherein activation of the third corresponding mode automatically locks the mobile electronic device and displays a security prompt.

16. The personal safety and emergency alert system of claim 13, wherein activation of the third corresponding mode automatically transmits a distress message to a predetermined emergency contact.

17. The personal safety and emergency alert system of claim 13, wherein the software application allows a scheduled activation of the first corresponding mode, the second corresponding mode, or the third corresponding mode based on a user preference.

18. The personal safety and emergency alert system of claim 13, wherein activation of the third corresponding mode generates a verbal announcement.

19. The personal safety and emergency alert system of claim 13, wherein the software application includes a notification settings interface configured to adjust an alert volume, a vibration setting, and a notification preference of the software application.

20. The personal safety and emergency alert system of claim 13, wherein the media recording module supports multiple file formats including a JPEG, an MP4, a HEIC, a TIFF, and a PNG.
